(19) United States
(12) Patent Application Publication
(10) Pub. No.: US 2020/0225463 A1
(43) Pub. Date: Jul. 16, 2020

(54) STRUCTURED LIGHT PROJECTOR AND STRUCTURED LIGHT DEPTH SENSOR

(71) Applicants: Interface Technology (ChengDu) Co., Ltd., Chengdu (CN); INTERFACE OPTOELECTRONICS (SHENZHEN) CO., LTD., Shenzhen (CN); GENERAL INTERFACE SOLUTION LIMITED, Zhunan (CN)

(72) Inventor: YI-SAN HSIEH, Zhunan (TW)

(21) Appl. No.: 16/432,184

(22) Filed: Jun. 5, 2019

(30) Foreign Application Priority Data
Jan. 14, 2019 (CN) 201910031973.4

(51) Int. Cl. G02B 26/08; G03B 21/00; G03B 21/20; H04N 5/74

(52) U.S. Cl. CPC G02B 26/0833; H04N 5/7458; G03B 21/2033; G03B 21/008

(57) ABSTRACT

A structured light projector able to project structured light for the depth-perception of objects in a scene includes a laser light source, a first lens on an optical path of the laser beams to collimate the laser beams, and a reflecting mirror. The reflecting mirror imparts a certain or more than one pattern to the light, a target object in the scene reflecting some of the structured light. A structured light depth sensor using the structured light projector is also provided. A depth sensing accuracy of the structured light depth sensor is improved without being limited to an arrangement of light source dots.

### FIELD

The subject matter herein generally relates to structured light projectors and sensors.

### BACKGROUND

Structured light depth sensors are widely used in face recognition, gesture recognition, 3D scanners, and precision machining, and are mainly divided into time identification and space identification technologies. Most face recognition and gesture recognition techniques use the space identification technique due to the requirement of identification speed and the limitation of sensing distance.

The structured light depth sensor actively uses a structured light projector to project structured light (or radiate light in a predetermined pattern) to a scene for feature calibration, and then a camera captures images of the scene. By comparing an image by the structured light projector with an image taken by the camera, a parallax of each point in the scene is obtained, thereby the depth of the space in the scene can be calculated. During the process of comparison, a block needs to be selected in the image taken by the structured light projector, and then the same block is found in the image taken by the camera, so the matching accuracy of the block directly affects a depth sensing calculation. The lower the matching accuracy of the block, the lower is the resolution of the depth sensing calculation. Therefore, there is room for improvement in the art.

### BRIEF DESCRIPTION OF THE DRAWINGS

Implementations of the present disclosure will now be described, by way of embodiment, with reference to the attached figures.

FIG. 1 is a structural block diagram of a structured light depth sensor according to an embodiment.

FIG. 2 is a schematic view of a structured light projector of the structured light depth sensor shown in FIG. 1.

FIG. 3 is a schematic view of a pattern of light which is reflected by a mirror within the structured light projector in FIG. 2.

FIG. 4 is a cross-sectional view of a reflecting mirror according to a first embodiment.

FIG. 5 is a cross-sectional view of a reflecting mirror according to a second embodiment.

FIG. 6 is an exploded view of a mirror unit of a reflecting mirror according to a third embodiment.

FIG. 7 is a cross-sectional view of a reflecting mirror according to a fourth embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one”. The term “circuit” is defined as an integrated circuit (IC) with a plurality of electric elements, such as capacitors, resistors, amplifiers, and the like.

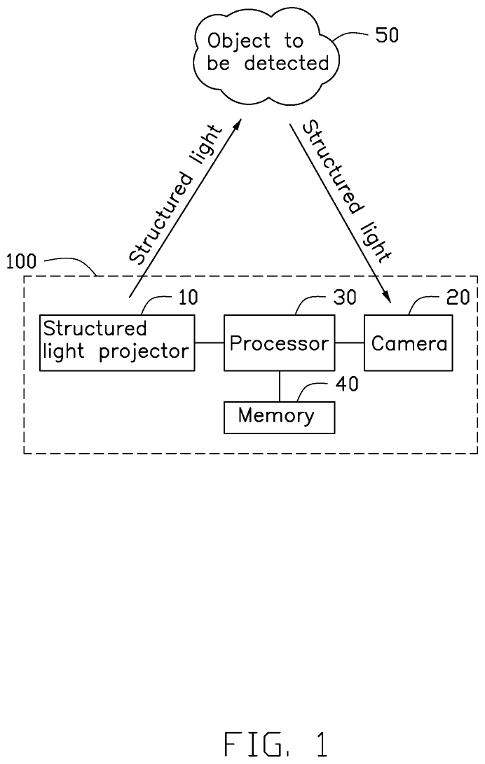

Referring to FIG. 1, a structured light depth sensor 100 includes a structured light projector 10, a camera 20, a processor 30, and a memory 40. The processor 30 is electrically connected to the structured light projector 10, the camera 20, and the memory 40. The memory 40 stores information of parameters of the camera 20 and a distance between the structured light projector 10 and the camera 20. The processor 30 controls the structured light projector 10 to project light onto an object 50 to be detected and controls the camera 20 to capture light reflected by the object 50. According to parameters of the camera and the distance between the projector and the camera in the memory 40, the light projected by the structured light projector 10 and the reflected light captured by the camera 20 enable calculation of a depth of the object 50, for depth-perception in images or otherwise.

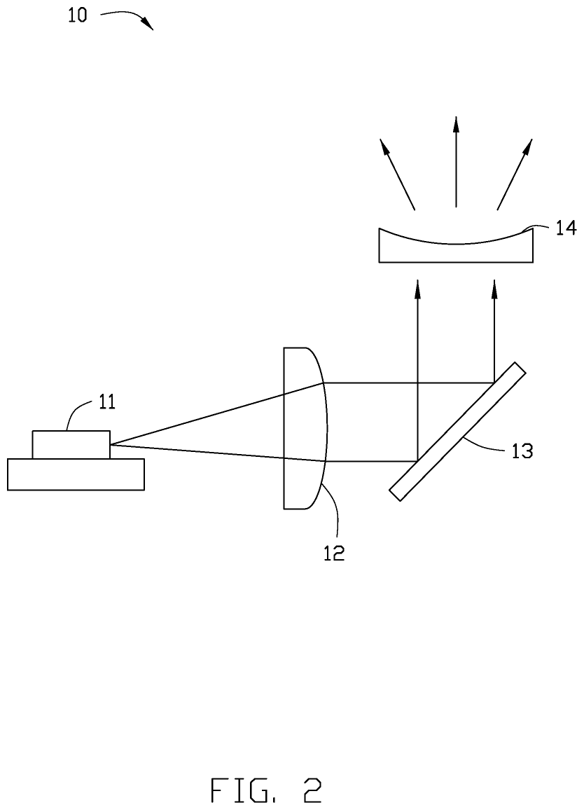

Referring to FIG. 2, the structured light projector 10 includes a light source 11, a first lens 12, a reflecting mirror 13, and a second lens 14. The light source 11 is opposite to the reflecting mirror 13. The first lens 12 is between the light source 11 and the reflecting mirror 13, and the second lens 14 is opposite to the reflecting mirror 13 and is located on an optical path after the reflecting mirror 13.

The light source 11 is a laser and includes at least one point light source, and the laser beam generated by the light source 11 propagates onto the first lens 12. The first lens 12 is a collimating lens for collimating the laser beam generated by the light source 11. The reflecting mirror 13 is for reflecting the laser beam light collimated by the first lens 12 and converting it into structured light. The second lens 14 is a diverging lens for adjusting a divergence angle of the structured light converted by the reflecting mirror 13.

In one embodiment, the light source 11 may be an infrared laser with a wavelength from 800 nm to 900 nm, a laser that generates other wavelengths may be selected according to actual needs. The reflecting mirror 13 includes a pattern such that the laser beam collimated by the first lens 12 is reflected by a surface of the reflecting mirror 13 to form a light pattern, and the detectable object 50 can therefore be subjected to feature calibration.

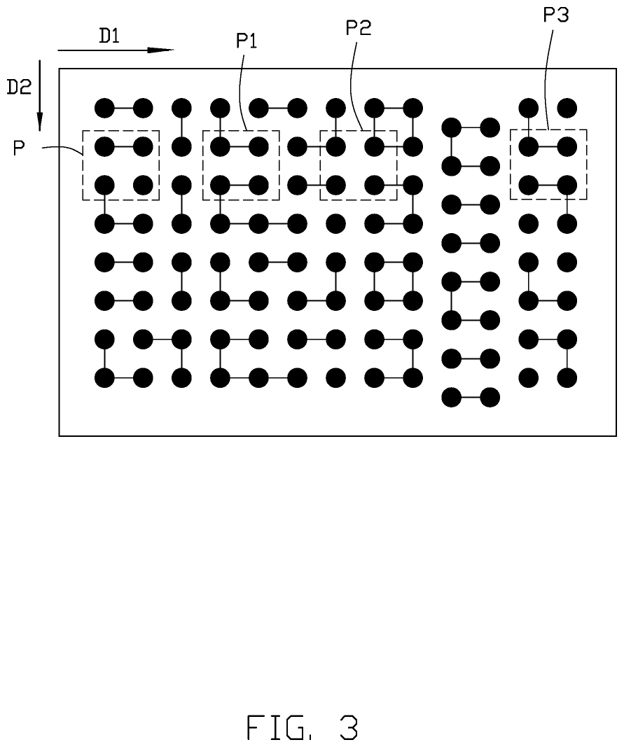

Referring to FIG. 3, in this embodiment, a dark filled portion represents the pattern of the light which is reflected by the mirror 13 (structured light). A rectangular region P along the first direction D1 or the second direction D2 is defined in the structured light, wherein there is no other region which contains the same pattern of the rectangular region P and has an area smaller than or equal to the rectangular region P. In this way, the matching accuracy of the light when calculating the depth of the object 50 is improved, thereby improving the accuracy of the depth information calculation. That is, the structured light has a plurality of area rectangles Pn, the area P1, the area P2, and the area P3 are randomly selected in the plurality of area rectangles Pn. The patterns of the area P and those of the area P1, the area P2, and the area P3 are different.

In some embodiments, the reflecting mirror 13 is an active mirror that generates structured light having preset patterns at a preset time interval.

The light source 11 generates a laser beam. After passing through the first lens 12, the laser beam is converted into collimated light, which is projected onto the reflecting mirror 13 and then reflected by the reflecting mirror 13 to the second lens 14. Since the reflecting mirror 13 has a predetermined pattern, the collimated light is reflected into the same pattern as that created on the reflecting mirror 13, and is projected to the object 50 after passing through the second lens 14. After the structured light is projected onto the object 50, the detectable object 50 can be subjected to feature calibration.

By providing a pattern on the surface of the reflecting mirror 13 in the structured light projector 10, the laser beam passing through the first lens 12 can be converted into light having a particular pattern. The structured light is compared with light having a diffraction pattern formed by a diffraction element. The diffraction pattern is a simple point-like speckle, and the similarity between the different regions of the structured light is too high. The resolution of the light depth sensing operation is therefore reduced. Directing structured light onto the detectable object 50 allows the resolution of the light depth sensing operation to be improved.

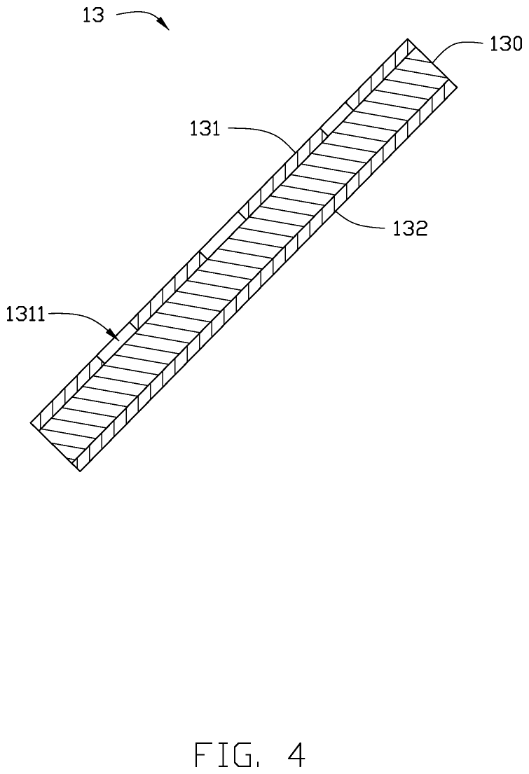

Referring to FIG. 4, the reflecting mirror 13 in the first embodiment includes a transparent substrate 130, a metal reflective layer 131 on one side of the transparent substrate 130, and a photoresist layer 132 on a side of the transparent substrate 130 away from the metal reflective layer 131. The metal reflective layer 131 includes the predetermined pattern to be applied to the light which strikes the mirror 13. The transparent substrate 130 can be, but is not limited to, a transparent glass.

The metal reflective layer 131 is formed by patterning a metal layer on the transparent substrate 130. A size of the metal reflective layer 131 is equal to or larger than the area of the collimated laser beam so that the collimated laser beam falls onto the metal reflective layer 131. The photoresist layer 132 completely covers a surface of the transparent substrate 130 away from the metal reflective layer 131. Openings 1311 are defined in the metal reflective layer 131. The laser beam irradiated to the metal reflective layer 131 excluding the openings 1311 is reflected, but the laser beam striking the openings 1311 is allowed to pass through. The photoresist layer 132 absorbs light and reflects very little, and the laser beam passing through the openings 1311 is lost, being absorbed by the photoresist layer 132. In this embodiment, the photoresist layer 132 is a black matrix. In other embodiments, the photoresist layer 132 may be fabricated from other photoresist materials that absorb light and have no reflectivity.

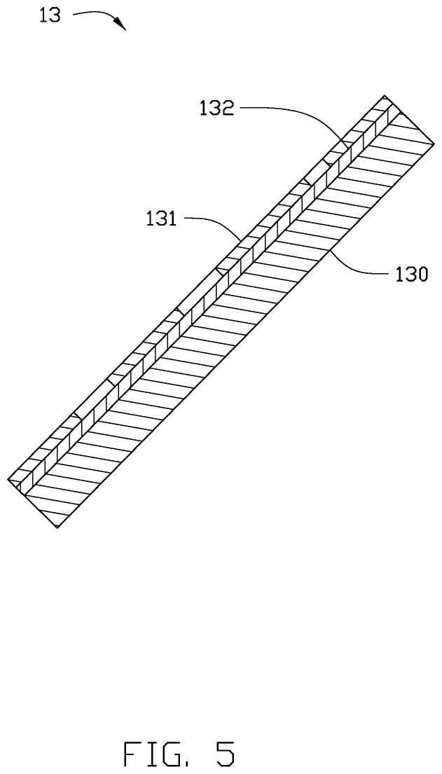

Referring to FIG. 5, the reflecting mirror 13 of the second embodiment differs from the reflecting mirror 13 of the first embodiment in the position of the photoresist layer 132. In this embodiment, the photoresist layer 132 is on one side of the transparent substrate 130, and the metal reflective layer 131 is on the side of the photoresist layer 132 away from the transparent substrate 130.

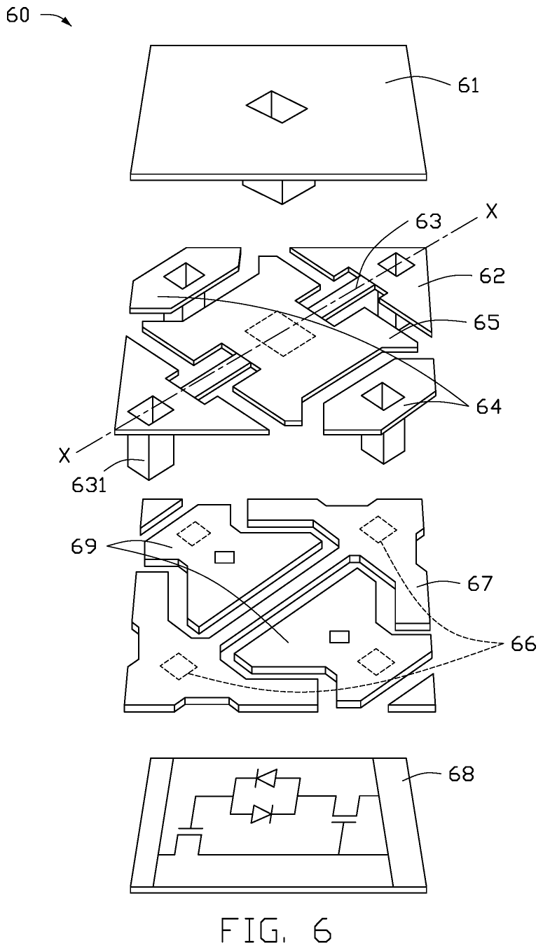

Referring to FIG. 6, the reflecting mirror 13 in the third embodiment is a digital micromirror device (DMD). The reflecting mirror 13 is an array of mirror units 60. Each mirror unit 60 includes a micromirror 61, a yoke 65 on one side of the micromirror 61 and connected to the micromirror 61, a hinge 63 connected to the yoke 65, and a torsion arm beam 62 connected to one end of the hinge 63. A hinge support post 631 is connected to the torsion arm beam 62, and a first address electrode 64. Each micromirror 61 is square and is suspended. Each micromirror 61 is made of an aluminum alloy, which has less mass and is easier to move. The torsion arm beam 62 is suspended by a hinge 63 on the hinge support post 631, and the micromirrors 61 are each rotatable about the axis X of the hinge 63.

A patterned metal layer is on a side of the first address electrode 64 away from the micromirror 61. The patterned metal layer includes a second address electrode 69, a bias reset electrode 66, and a landing platform 67. The landing platform 67 limits the angle of deflection of the micromirror 61, from positive 12 degrees to negative 12 degrees or from positive 10 degrees to negative 10 degrees. A static memory 68 is on a side of the landing platform 67 away from the micromirror 61.

The yoke 65 is coupled to the bias reset electrode 66 by the hinge 63, the torsion arm beam 62, and the hinge support post 631. The bias reset electrode 66 supplies a bias voltage to the yoke 65 and the micromirror 61. Since both the micromirror 61 and the yoke 65 are fixed in connection, the micromirror 61 and the yoke 65 have the same bias voltage. The second address electrode 69 of the twist arm beam 62 and the first address electrode 64 of the micromirror 61 are both connected to the underlying static memory 68.

Each of the mirror units 60 is individual, and some of the micromirrors 61 can be flipped at different angles, so that the light reflected by the micromirrors 61 can assume different angles. The light (the structured light) reflected by the reflecting mirror 13 to the second lens 14 is adjusted by adjusting the reflection angles of the micromirrors 61.

In operation, the micromirror 61 and the yoke 65 have the same bias voltage. The second address electrode 69 and the first address electrode 64 have different compensation voltages. Due to the difference in potential, an electrostatic effect is generated between the micromirror 61 and the first address electrode 64, the yoke 65, and the second address electrode 69. Since the first address electrode 64 and the second address electrode 69 are fixed, the electrostatic forces of the micromirror 61 and the yoke 65 with respect to both sides of the axis X are different, resulting in rotation of the micromirror 61 and the yoke 65 relative to the axis X.

Each mirror unit 60 has three steady states: positive 10 or 12 positive (on), 0 degrees (no signal), and negative 10 or 12 degrees (off). When the mirror unit 60 is supplied with a signal “1”, the micro-mirror 61 is deflected from the equilibrium position by positive 10 or 12 degrees, and the reflected laser beam is passed to the second lens 14 in the optical axis direction. When the micromirror 61 is deflected from the equilibrium position by negative 12 degrees or negative 10 degrees (signal “0”), the reflected laser beam does not pass through the second lens 14. In one embodiment, binary “1” and “0” states of the control signal correspond to the “on” and “off” states of the mirror unit 60. When a sequence of control signals is written to the static memory 68, the incident light is modulated by the digital micromirrors and a pattern can be formed on the exiting light before it reaches lens 14.

In this embodiment, the mirror (the digital micromirrors) of the structured light projector 10 can modulate the laser beam passing through the first lens 12 by changing the steady state of each mirror unit 60, so that the structured light projector 10 can project structured light having preset patterns at a preset time interval.

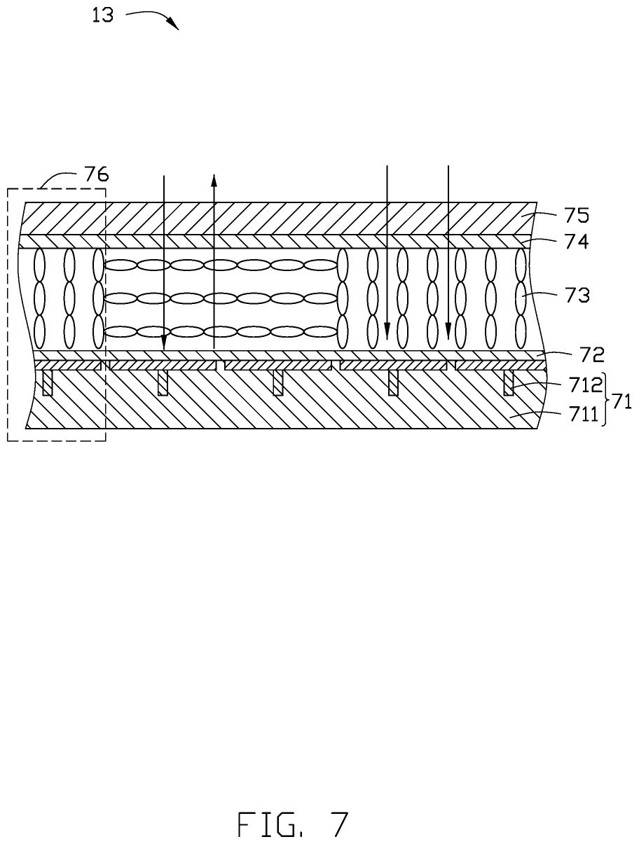

Referring to FIG. 7, the reflecting mirror 13 of the fourth embodiment is a liquid crystal on silicon (LCoS). The reflecting mirror 13 includes a first substrate 71, a reflective electrode layer 72 on a side of the first substrate 71, a liquid crystal molecular layer 73 on a side of the reflective electrode layer 72 away from the first substrate 71, a liquid crystal molecular layer 73, a common electrode layer 74 on a side of the liquid crystal molecule layer 73 away from the reflective electrode layer 72, and a second substrate 75 on a side of the common electrode layer 74 away from the liquid crystal molecular layer 73. The first substrate 71 includes a silicon substrate 711 and an active display driving matrix 712 on a side of the silicon substrate 711 adjacent to the reflective electrode layer 72. The reflective electrode layer 72 can be controlled by the active display driving matrix 712.

As shown in FIG. 7, the reflecting mirror 13 defines pixels 76. The active display driving matrix 712 is provided with one switching transistor corresponding to each pixel 76. Thus, each switching transistor in the active display driving matrix 712 can control the electric field in the liquid crystal molecular layer 73 corresponding to each pixel 76 by controlling the reflective electrode layer 72. Thereby, the angle of rotation of the laser beam incident on the region corresponding to each pixel 76 is adjusted, and an amount of laser beam entering and exiting the region corresponding to each pixel 76 is controlled, thus forming the structured light.

In an embodiment, the reflective electrode layer 72 may be made of an aluminum plating layer. The common electrode layer 74 is transparent, and may be made of indium tin oxide (ITO). The second substrate 75 is transparent, and may be made of glass.

The structured light projector 10 using the reflecting mirror 13 (LCoS) of the present embodiment can control the amount of light entering and exiting each pixel 76, so that the structured light projector 10 can project structured light having preset patterns at a preset time interval.

It is to be understood, even though information and advantages of the present exemplary embodiments have been set forth in the foregoing description, together with details of the structures and functions of the present exemplary embodiments, the disclosure is illustrative only. Changes may be made in detail, especially in matters of shape, size, and arrangement of parts within the principles of the present exemplary embodiments to the full extent indicated by the plain meaning of the terms in which the appended claims are expressed.

What is claimed is:

1. A structured light projector, comprising:
a light source adapted for emitting laser beams;
a first lens on an optical path of the laser beams, the first lens configured for collimating the laser beams; and
a reflecting mirror on a side of the first lens away from the light source, wherein the reflecting mirror comprises a predetermined pattern for reflecting and converting the laser beams passing through the first lens into structured light having a same pattern as the predetermined pattern.

2. The structured light projector of claim 1, further comprising a second lens on an optical path of the structured light for adjusting a divergence angle of the structured light.

3. The structured light projector of claim 1, wherein the reflecting mirror comprises a metal reflective layer having the predetermined pattern.

4. The structured light projector of claim 3, wherein the reflecting mirror further comprises a transparent substrate and a photoresist layer, the metal reflective layer is on a side of the transparent substrate, and the photoresist layer is on a side of the transparent substrate away from the metal reflective layer.

5. The structured light projector of claim 3, wherein the reflecting mirror further comprises a transparent substrate and a photoresist layer, the metal reflective layer is on a side of the transparent substrate, and the photoresist layer is between the transparent substrate and the metal reflective layer.

6. The structured light projector of claim 1, wherein the light source comprises at least one point light source.

7. The structured light projector of claim 2, wherein the structured light defines a rectangular region, and the structured light comprises no other region which has a same pattern as the rectangular region and has an area smaller than or equal to the rectangular region.

8. A structured light projector, comprising:
a light source adapted for emitting laser beams;
a first lens on an optical path of the laser beams, the first lens configured for collimating the laser beams; and
a reflecting mirror on a side of the first lens away from the light source, wherein the reflecting mirror is configured for reflecting and converting the laser beams passing through the first lens into structured light having preset patterns at a preset time interval.

9. The structured light projector of claim 8, wherein the reflecting mirror is a digital micromirror comprising a plurality of mirror units, and by adjusting a reflection angle of each of the plurality of mirror units, the structured light of preset patterns is projected at a preset time interval.

10. The structured light projector of claim 8, wherein the reflecting mirror is a liquid crystal on silicon comprising a plurality of pixels, and by adjusting an amount of laser beams entering and exiting a region corresponding to each of the plurality of pixels, the structured light of preset patterns is projected at a preset time interval.

11. The structured light projector of claim 8, wherein the light source comprises at least one point light source.

12. The structured light projector of claim 8, wherein the structured light defines a rectangular region, and the structured light comprises no other region which has a same pattern of the rectangular region and has an area smaller than or equal to the rectangular region.

13. The structured light projector of claim 8, further comprising a second lens on an optical path of the structured light for adjusting a divergence angle of the structured light.

14. A structured light depth sensor for sensing a depth of an object, comprising:
a structured light projector for projecting patterned structured light to the object, the structured light projector comprising:
a light source adapted for emitting laser beams;
a first lens on an optical path of the laser beams, the first lens configured for collimating the laser beams; and
a reflecting mirror on a side of the first lens away from the light source, wherein the reflecting mirror is configured for reflecting and converting the laser beams passing through the first lens into structured light;
a camera on one side of the structured light projector, the camera configured for capturing structured light reflected by the structured light projector after being projected onto the object;
a memory, the memory configured for storing information of parameters of the camera and a distance between the projector and the camera; and
a processor electrically connected to the projector, the camera, and the memory, wherein the processor controls the structured light projector to project light to the object, and controls the camera to capture light reflected by the object, and according to the parameters of the camera and the distance between the projector and the camera in the memory, the light projected by the structured light projector, and the reflected light captured by the camera calculate a depth of the object.

15. The structured light depth sensor of claim 14, wherein the reflecting mirror comprises a metal reflective layer having a predetermined pattern, and the structured light having a same pattern as the predetermined pattern.

16. The structured light depth sensor of claim 15, wherein the reflecting mirror further comprises a transparent substrate and a photoresist layer, the metal reflective layer is on a side of the transparent substrate, and the photoresist layer is on a side of the transparent substrate away from the metal reflective layer.

17. The structured light depth sensor of claim 15, wherein the reflecting mirror further comprises a transparent substrate and a photoresist layer, the metal reflective layer is on a side of the transparent substrate, and the photoresist layer is between the transparent substrate and the metal reflective layer.

18. The structured light depth sensor of claim 14, wherein the reflecting mirror is a digital micromirror comprising a plurality of mirror units, and by adjusting a reflection angle of each of the plurality of mirror units, the structured light of preset patterns is projected at a preset time interval;

19. The structured light depth sensor of claim 14, wherein the reflecting mirror is a liquid crystal on silicon comprising a plurality of pixels, and by adjusting an amount of laser beams entering and exiting a region corresponding to each of the plurality of pixels, the structured light of preset patterns is projected at a preset time interval.

20. The structured light depth sensor of claim 14, further comprising a second lens on an optical path of the structured light for adjusting a divergence angle of the structured light.
